(19) United States
(12) Patent Application Publication
(10) Pub. No.: US 2026/0176507 A1
(43) Pub. Date: Jun. 25, 2026

(54) WIRELESS LABEL CONSTRUCTIONS WITH A FUNCTIONAL LAYER CONTAINING NONIONIC SURFACTANTS

(71) Applicant: Avery Dennison Corporation, Mentor, OH (US)

(72) Inventors: Eric L. BARTHOLOMEW, Mill Hall, PA (US); Anna COWFER, Renovo, PA (US); Nishad DHOPATKAR, Lock Haven, PA (US); Kevin O. HENDERSON, Willoughby Hills, OH (US); Yu-Hsuan LEE, Williamsport, PA (US); Alex NYARKO, Williamsport, PA (US); Sivaprakash SHANMUGAM, State College, PA (US)

(21) Appl. No.: 19/427,849

(22) Filed: Dec. 19, 2025

Related U.S. Application Data
(60) Provisional application No. 63/736,969, filed on Dec. 20, 2024.

(51) Int. Cl. C09J 11/08; C09J 7/38; G06K 19/07

(52) U.S. Cl. CPC C09J 11/08; C09J 7/385; G06K 19/0723; C09J 2203/326; C09J 2203/334; C09J 2301/408; C09J 2301/414

(57) ABSTRACT

Wireless label constructions, methods of making, and methods of using the wireless label constructions are disclosed. The wireless label constructions comprise one or more functional layers, which preferably contain nonionic surfactants. The wireless label construction improves the readability when placed on a package containing a high dielectric material.

### CROSS REFERENCE TO RELATED APPLICATIONS

The present application claims priority to U.S. Provisional Application No. 63/736,969 filed on Dec. 20, 2024, the entire contents and disclosure of which is hereby incorporated by reference.

### FIELD OF INVENTIONS

The present disclosure generally relates to wireless label constructions, and methods of making and methods of using the wireless label constructions. More particularly the wireless label constructions comprise a wireless identification device and one or more functional layers, which preferably contain nonionic surfactants.

### BACKGROUND

Wireless identification devices, such as radio frequency identification (RFID) tags, near field communication (NFC) devices, and electronic article surveillance (EAS) systems, are integral to modern industries for tracking, identifying, and monitoring objects. These devices, which include an antenna and a chip, facilitate wireless transmission and reception of information, enabling their widespread application in sectors such as retail, logistics, healthcare, and manufacturing. Wireless identification technologies offer several benefits, including improved inventory control, reduced waste, and enhanced product tracking and traceability.

However, the performance of these devices is significantly influenced by the substrate material they are attached to. When these devices are placed near substrates with high dielectric constants, their impedance changes due to interactions with the surrounding medium. The device's electric field couples with the substrate, and the high dielectric constant material slows down the electromagnetic wave propagation. As a result, the effective wavelength shortens, causing the resonant frequency to shift downward. In other words, the wireless identification device resonates at a lower frequency than it would in free space.

Further, different substrates such as cardboard, plastic, glass, metal, liquids or food products have distinct dielectric properties that impact antenna impedance matching and overall efficiency. This variability often results in reduced antenna performance, such as diminished read range, detuning, or signal loss, particularly when a tag designed for one material is used on another. This challenge is a critical barrier to the broader adoption of these devices in environments with such interfering surfaces.

Efforts to mitigate these poor performance issues have led to the development of various solutions, including specialized antenna designs, electromagnetic shielding materials, and physical separators. However, these approaches often result in bulky or complex constructions that can be challenging to manufacture, apply, and use efficiently, particularly in scenarios requiring thin, flexible, and adaptable label constructions.

Foamable materials have been used in various industries for insulation, cushioning, and other applications where a change in volume upon exposure to heat is desirable. However, the integration of such materials into wireless label constructions presents challenges in terms of manufacturing, activation, and maintaining the functionality of the wireless identification devices. Traditional foamable materials require high temperatures (often exceeding 200° C.) for activation, which can damage or destroy sensitive components of RFID and other wireless identification devices. Another disadvantage is maintenance of the structural integrity of the foamable material throughout the life cycle of a label. Moreover, inclusion of foamable material into label constructions leads to increased label thickness. This constraint has limited the integration of foamable materials into wireless label constructions, especially where a printable label is desired. Furthermore, the physical constraints of the product packaging and labeling often limit the size and the placement options for wireless identification devices.

The growing demand for efficient, adaptable, compact, and cost-effective wireless identification solutions necessitates the development of novel materials and methods. There is a pressing need for wireless label constructions that not only maintain functionality near high dielectric constant materials but also remain thin, flexible, and easy to produce. Additionally, solutions that can achieve foam expansion without subjecting wireless devices to damaging temperatures will significantly enhance the practicality and versatility of these technologies in diverse applications.

### SUMMARY

The present disclosure relates generally to wireless label construction, and methods of making and methods of using the wireless label constructions. In some embodiments, the wireless label constructions are applied as labels to substrates having high dielectric constants.

In one aspect, there is provided a wireless label construction comprising a face layer having a printable surface and an adhesive surface, wherein the printable surface opposes the adhesive surface; a wireless identification device, an adhesive layer, wherein the wireless identification device is positioned between the face layer and the adhesive layer; and one or more functional layers, each of the functional layers comprising nonionic surfactant.

In one aspect, there is provided a wireless label construction comprising a face layer having a printable surface and an adhesive surface, wherein the printable surface opposes the adhesive surface; a wireless identification device; an adhesive layer, wherein the wireless identification device is positioned between the face layer and the adhesive layer; and one or more functional layers, each of the functional layers comprising an expandable component, and the one or more functional layers are positioned between the face layer and the wireless identification device, and/or between the adhesive layer and the wireless identification device, wherein at least one of the one or more functional layers comprises an acrylic emulsion, a nonionic surfactant, and expandable particles wherein the expandable particles comprising a core and a polymeric shell.

The summary of the invention is provided as a general introduction to some of the embodiments of the invention and is not intended to be limiting. Additional example embodiments, including variations and alternative configurations, of the invention are provided herein.

### BRIEF DESCRIPTION OF FIGURES

The accompanying figures, which are included to provide a further understanding of the present disclosure and are incorporated in and constitute a part of this specification, illustrate embodiments of the described herein and, together with the description, serve to explain the principles of the embodiments. Non-limiting and non-exhaustive examples are described with reference to the following figures. In the drawings:

FIG. 1 illustrates a cross-sectional view of an exemplary embodiment of a wireless label construction according to aspects of the disclosure.

FIG. 2 illustrates an exemplary embodiment of a wireless label construction placed on a package containing a high dielectric material according to aspects of the disclosure.

FIG. 3 illustrates an exemplary embodiment of a wide armed dipole antenna for a wireless identification device according to aspects of the present disclosure.

FIGS. 4A-4E illustrate cross-sectional views of exemplary embodiments of various wireless label constructions according to aspects of the disclosure.

FIGS. 5A & 5B illustrate cross-sectional views of exemplary embodiments of functional lanes for a wireless label construction according to aspects of the disclosure.

It will be noted that the wireless label constructions and their respective parts in the figures are for illustrative purposes only and are not drawn to scale.

### DETAILED DESCRIPTION

### Definitions

As employed above and throughout the disclosure, the following terms, unless otherwise indicated, shall be understood to have the following meanings.

As used herein, the terms “comprises,” “comprising,” “includes,” “including,” “has,” “having” or any other variation thereof, are intended are open-ended and cover a non-exclusive inclusion. For example, a process, method, article, or apparatus that comprises a list of elements is not necessarily limited to only those elements but may include other elements not expressly listed or inherent to such process, method, article, or apparatus. Also, the use of “a” or “an” is employed to describe elements and components described herein. This is done merely for convenience and to give a general sense of the scope of the present disclosure. This description should be read to include “one” or “at least one” and the singular also includes the plural, unless it is obvious that it is meant otherwise by the context. As used herein, the term “about,” when referring to a measurable value such as an amount, a temporal duration, and the like, is meant to encompass variations of ±10%, preferably, ±8%, more preferably, ±5%, even more preferably, ±1%, and yet even more preferably, ±0.1% from the specified value, as such variations are appropriate to perform the disclosed methods.

As used herein, “article” means an item or object, such as a package. Suitable examples of articles used in the context of this present disclosure include, but are not limited to packaging articles, such as for example containers, bottles, clam shell containers, flexible packaging containers, food containers, wrapping films, and non-food containers. In some embodiments, the article may be a package that contains a high-dielectric material.

As used herein, “wireless identification device” means a device that utilizes wireless technology to communicate with another device. Examples include ultra-high frequency (UHF), near-field communication (NFC), bluetooth low energy (BLE), long-term evolution (LTE), and electronic article surveillance (EAS) inlays. Wireless identification devices may include passive or active devices. Passive devices do not include an internal power source and are powered by electromagnetic energy transmitted from a reader. Different types of passive tags operate on different frequencies. Active devices, including an internal power source, continuously broadcast their own signal.

As used herein, “integrated circuit” or “chip” means a piece of hardware designed to implement one or more functions. Integrated circuits or chips can form, for example, a sensor or a transmission-reception device, have a data or memory processing capacity and other functions. Integrated circuits or chips typically have a planar structure (whose overall shape is usually that of a small plate), include one or more semiconductor materials (as well as other materials, in particular, metallic materials and/or electrically insulating oxides), and can integrate various components, active or passive (for example transistor, diode, resistor, radiating or guiding structure).

As used herein, “conductive” means able to conduct electricity or induce electrical currents.

“Conductive materials” as used herein means materials that are able to conduct electricity or induce electrical currents.

As used herein, the term “antenna” means a structure used to transmit or receive electromagnetic waves.

As used herein, “pressure sensitive adhesive” or “PSA” in general refers to materials that form a bond upon pressure activation. Preferably, the bond is formed without undergoing a phase change and the bond may retain tackiness at room temperature. In some embodiments, the PSA may refer to a material identified by the Dahlquist criterion, which defines a pressure sensitive adhesive as an adhesive having a one-second creep compliance of greater than 1×10⁻⁶ cm²/dyne as described in Handbook of PSA Technology, Donatas Satas (Ed.), 2^{nd} Edition, page 172, Van Nostrand Reinhold, New York, N.Y., 1989. Since modulus is, to a first approximation, the inverse of creep compliance, pressure sensitive adhesives may also be defined as adhesives having a Young's modulus of less than 1×10⁶ dynes/cm². Pressure sensitive adhesive also include materials having aggressively and permanently tacky properties at room temperature and firmly adheres to a variety of dissimilar surfaces upon mere contact, without the need of more than finger or hand pressure, and which may be removed from smooth surfaces without leaving a residue, as described in Glossary of Terms Used in the Pressure Sensitive Tape Industry provided by the Pressure Sensitive Tape Council, 1996. Accordingly, a suitable pressure sensitive adhesive may preferably have a room temperature storage modulus within the area defined by the following points as plotted on a graph of modulus versus frequency at 25° C.: a range of moduli from about 2×10⁵ to 4×10⁵ dynes/cm² at a frequency of about 0.1 radians/sec (0.017 Hz), and a range of moduli from about 2×10⁶ to 8×10⁶ dynes/cm² at a frequency of approximately 100 radians/sec (17 Hz). See, for example, Handbook of PSA Technology.

As used herein, the term “film” refers to an object that has one dimension (thickness) that is relatively small compared to the other two dimension (length and width). The surface of a film defined by its length and width is also known as the “face” of the film (or as a first face and second face).

As used herein, “polymeric film” means a film including at least one of polymers, copolymers (e.g., polymers formed using two or more different monomers), oligomers, and combinations thereof.

As used herein, “copolymer” is used herein to refer to polymers containing copolymerized units of at least two different monomers (e.g. a dipolymer, terpolymer, tetrapolymer, and so on).

As used herein, the prefix “(meth)acryl-” refers to both “methacryl-” and “acryl-”, such as in “(meth)acrylic” (meaning both methacrylic and acrylic), “(meth)acrylate” (meaning both methacrylate and acrylate), and “(meth)acrylonitrile” (meaning both methacrylonitrile and acrylonitrile). The term “(meth)acrylate” refers to monomeric acrylic or methacrylic esters of alcohols. Acrylate and methacrylate monomers are referred to collectively herein as “(meth)acrylate” monomers. Polymers prepared from (meth)acrylate monomers are referred to as (meth)acrylate polymers.

As used herein, the term “acrylic polymer” refers to at least one (meth)acrylate homopolymer or copolymer and may include a blend of different (meth)acrylate polymers and copolymers.

By “filler” is meant herein particles or fibers added to polymeric compositions to improve or change properties (such as density, tensile strength, toughness, heat resistance, color, and clarity), provide a cost advantage, or a combination thereof. Fillers may be more dense or less dense than the materials to which they are added, depending on the filler. Typical fillers include, but are not limited to, calcium carbonate (ground or precipitated), kaolin, talc, carbon black, and the like.

By “pigment” is meant herein an organic, inorganic or synthetic substance that imparts whiteness or color, especially a powdered substance that may be mixed with a liquid in which it is relatively insoluble and that is typically used to impart color to coating materials (such as paints) or to polymers, inks, plastics, and rubber.

As used herein, “RF-annihilating substances” mean substances that interfere with radio frequency (RF) signals and reduce or completely destroy RF signal readability. Some of the examples of RF-annihilating substances are inter alia metals, liquids, and substances containing higher liquid content, such as liquid food products, fatty foods, meat and the like. Exemplary high-dielectric materials may include proteins such as meat including but not limited to beef, chicken, turkey, pork, seafood, as well as other similar proteins. Alternatively, the substances having high dielectric constants may be termed as RF-annihilating substances as they are capable of interfering with RF signals and detuning them.

As used herein, “physical expansion” means a change in a material's volume, or thickness, due to a change in at least one physical factor, such as for example temperature, pressure, or other physical factors. The material's chemical composition remains the same. In some embodiment, the change may be reversible.

As used herein, “chemical expansion” means a change in a material's volume, or thickness, due to a change in its composition. This change creates new substances with different chemical and physical properties.

### INTRODUCTION

As noted hereinabove, the challenges in the implementation of wireless identification devices when placed on or near RF-annihilating objects (i.e. objects having a high dielectric constant), such as metal surfaces or liquids or substances with high liquid content, limit their adaptation to a wide range of packaging and labeling solutions. Particularly, the adaptation of wireless identification devices in the food industry is challenging. Typically, the diverse nature of the products in the food industry, including different types of meats (e.g. beef, pork, chicken, fish, etc.), and other food products, have different water content and therefore affect the signal readability of the wireless identification device. Without limitations, the high-dielectric materials may also include other proteins such as milk, yogurt, and eggs or egg products. The high-dielectric materials generally may have a relative permittivity (Er) that is less than or equal to 60, e.g. less than or equal to 55, or less than or equal to 50. The RFID device may also be used on packages with a relative permittivity of greater than 60. The relative permittivity (Er) for high-dielectric materials should be greater than 5, e.g., preferably greater than 15 or more preferably greater than 20. The RFID devices described herein have improved adaptability to respond to variations across multiple types of high-dielectric materials. Accordingly, in terms of ranges, the relative permittivity (&r) may be from 10 to 60, e.g., preferably from 15 to 55, preferably from 20 to 55, preferably from 25 to 55, preferably from 30 to 55, preferably from 35 to 55 or more preferably from 40 to 55. The temperature of the package (frozen or thawed), moisture content, and fat percentage of the protein are all factors that can contribute to variations into the relative permittivity (Er). These high-dielectric materials can significantly affect the performance of RFID tags by altering their resonant frequency and reducing their radiation efficiency.

The relative permittivity and loss tangent (“tan 8”) can be measured by any appropriate method using dielectric spectroscopy or resonator cavities which are commonly used dielectric analysis techniques. At ambient temperature, permittivity and dielectric losses of dielectric materials s can be considered as relatively constant in particular in the bandwidth of interest. The permittivity value of a material and also to its tan 8 loss factor at a given frequency for example. Unless otherwise noted, the values indicated in this description and the claims that follow correspond to those measured at any frequency within the band of 800-1000 MHz. The measurements may be test the variation between temperature of 20° C. and freezer temperature of −18° C. In particular, the values relative permittivity and tan 8 may be measured by means of a DAK-TL2 using open coaxial probes and relative permittivity and tan 8 of the material under test are calculated from the reflection coefficient measured at the probe flange. In DAK-TL2, software calculates the relative permittivity and tan & constant from the measurement on the basis of the impedance measured at the end of the open-ended coaxial probe connected to a vector network analyzer.

The proximity of the wireless identification device to these materials may significantly affect the performance of the device's antenna, potentially detuning it and reducing its read range and overall effectiveness. Various approaches have been developed to address this issue, including the use of specialized antenna designs, the incorporation of some electromagnetic shielding materials, and the creation of a physical separation between the device and the problematic surface. However, these conventional solutions often result in bulky or complex constructions that may be difficult to manufacture, apply, or use in certain applications.

It has now been discovered that some functional layers resolve at least some of the aforementioned deficiencies of conventional wireless identification devices. Without being bound by theory, it is postulated that the use of the disclosed functional layers that convert from an initial state to a final state (via external stimulus) are particularly suited to overcome the problems associated with RFID performance, e.g., the ability to maintain functionality near high dielectric constant materials, while synergistically providing processing and use benefits, e.g., the ability to remain thin, flexible, and easy to produce and the ability to avoid damaging temperatures that would destroy components of the wireless identification devices.

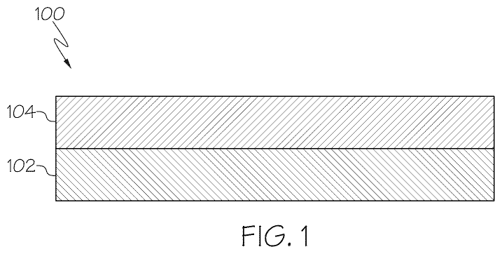

In one aspect, the present disclosure generally relates to a wireless label construction that enhances readability when applied to objects including RF-annihilating substances (including but not limited to liquids, metals, glass, and materials with high water content) and methods of making and methods of using the wireless label constructions. The wireless label construction includes a wireless identification device and at least one functional layer. In some embodiments, the functional layer may be converted from an initial state to a final state upon application of an external stimulus. In accordance with one embodiment of the present disclosure, the wireless label construction 100 comprises a wireless identification device 102 and a functional layer 104 as shown in FIG. 1. The functional layer 104 may be placed on either surface of the wireless identification device 102. In some embodiments, the wireless identification device 102 may include a first surface and a second surface, and the functional layer 104 may include a first surface and a second surface, such that the functional layer 104 is disposed on at least one of the first surface and the second surface of the wireless identification device 102. The area of the functional layer 104 may be larger than the area of the wireless identification device 102.

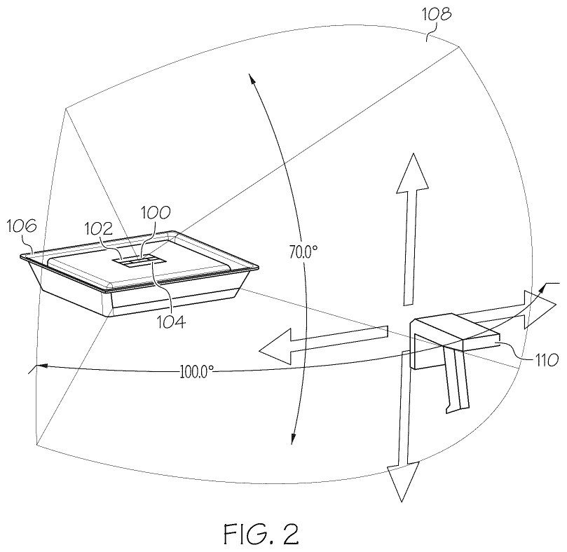

In some embodiments, the functional layer 104 may be positioned between the wireless identification device 102 and a package 106 containing a high-dielectric material. As shown in FIG. 2, the wireless identification device 102 may interact with a sensitivity aperture 108 of a RFID reader 110. The RFID reader 110 may be, for example, a mobile reader such as a hand-held reader or a robotic reader. In other embodiments, the RFID reader 110 may be mounted to a fixed position, such as a ceiling or access point. Particularly, when a RFID reader 110 is activated, a UHF RF signal may be transmitted from the RFID reader 110. In such instances, when the wireless identification device 102 is influenced under the transmitted UHF RF signal, the wireless identification device 102 receives and transmits back the UHF RF signal to the reader 110 with the information stored in the RFID integrated circuit (IC) chip. In some embodiments, the information stored in the RFID IC chip may include, for example, an item identification system, an item locating system, or an item indication system. The item identification system as used herein may include item identification, item location, item indication, as well as other suitable information.

By positioning the functional layer 104 between the wireless identification device 102 and package 106 the readability of the wireless identification device 102 may be improved. This provides a readable frequency range that overcomes the inefficiencies caused by the high-dielectric material. In some embodiments, the functional layer 104 may be increased in thickness and/or density, by a stimulus, such as either through expansion or foam generation, that creates separation between the wireless identification device 102 and the high-dielectric and conductive environment contained within the package 106. The increased separation, which may depend on the degree of expansion or foam generation, helps to reduce interference from high dielectric and conductive environments that might otherwise impair the performance of the wireless identification device 102.

In some embodiments, the functional layer 104 may be placed on a surface of the wireless identification device 102 that is opposite to the package 106. Additionally, wireless label constructions described herein may contain multiple functional layers, adhesive layers, as well as other non-functional layers that are further described herein. Various exemplary constructions are described herein to provide improved readability of the wireless identification device 102 on packages containing a high-dielectric material.

### Wireless Identification Device

The wireless label construction may include any suitable wireless identification device, several of which are readily commercially available. In some embodiments, the wireless identification device may be a RFID device. The RFID device may comprise a RFID integrated circuit chip and an antenna as described further herein. In general, RFID devices (also referred to as tags or labels) may retain and transmit information to uniquely identify individuals, packages, inventory and the like. RFID devices also may be characterized as those to which information is written only once (although the information may be read repeatedly) and those to which information may be written during use. In some embodiments, the wireless identification device is a RFID passive device that does not include a power source. In the case of passive tags, in order to retrieve the information from the chip, a “base station” or “reader” sends an excitation signal to the wireless identification device to wake up the device. The excitation signal energizes the wireless identification device, and the RFID circuitry transmits the stored information back to the reader. The “reader” receives and decodes the information from the wireless identification device. In some embodiments, the wireless identification device is an active RFID device that includes a power source.

In some embodiments, the wireless identification device is selected from an ultra-high frequency device (UHF), a near field communication device (NFC), a Bluetooth low energy device (BLE) a long-term evolution device (LTE) and an electronic article surveillance (EAS) device. In some embodiments, the wireless identification device may be a UHF device. UHF devices include passive RFID devices that use a frequency ranging of about 865 MHz to 928 MHz. This frequency range provides long read distances. In some embodiments, the wireless identification device may be an NFC device. NFC devices are passive devices that typically use a smartphone or tablet that has NFC capabilities. Read ranges for NFC devices are short, typically no more than 1.6 inches. In some embodiments, the wireless identification device may be a BLE device. BLE devices are passive devices that use the same radio wavebands as Bluetooth (about 2.402 GHz to 2.48 GHz) and provide a read range of about 100 meters. In some embodiments, the wireless identification device may be an LTE device, also known as a 4G device. LTE devices are used in devices for communication with wireless cellular networks (uses 450 MHz-3.8 GHz).

In some preferred embodiments, the wireless identification device may be an ultra-high frequency device (UHF) device. The UHF device may include features such as non-meandering antenna paths, specific impedance-matching techniques, antenna configurations, and radiation pattern manipulations. UHF device is configured to modify its readability when placed in high dielectric and conductive environment.

The wireless identification device may comprise a RFID integrated circuit (IC) chip and an antenna as described further herein. In some embodiments, the wireless identification device may incorporate antenna designs that are configured for efficient operation across a range of dielectric conditions. Suitable antenna designs include dipole antennas, T-match antennas, reversed T-match antennas and impedance-matching loop antennas. These antenna designs may include features such as non-meandering antenna paths, specific impedance-matching techniques, antenna configurations, radiation pattern manipulation, or combinations thereof. The antenna when used in the wireless identification device may be capable of modifying its readability, which may be a composite of sensitivity, backscatter, and radiation patterns, in response to complex dielectric and conductive environments.

According to some embodiments, an antenna design for a wireless identification device that will be used with high-dielectric materials involves a balance of electrical length and physical size. While a shorter electrical length may be desirable for achieving the necessary high resonance frequency, a larger physical size—and therefore a greater surface area—typically increases radiation resistance. This increased resistance enhances the antenna's radiation efficiency, boosting its performance when applied to high-dielectric materials. However, it has been found that the antenna's size may also need to be defined to fit within the constraints of the primary or secondary label, as in the case of applying the wireless label construction to an article of meat. In addition, increasing the size of an antenna will eventually result in a decrease of the antenna's resonance frequency.

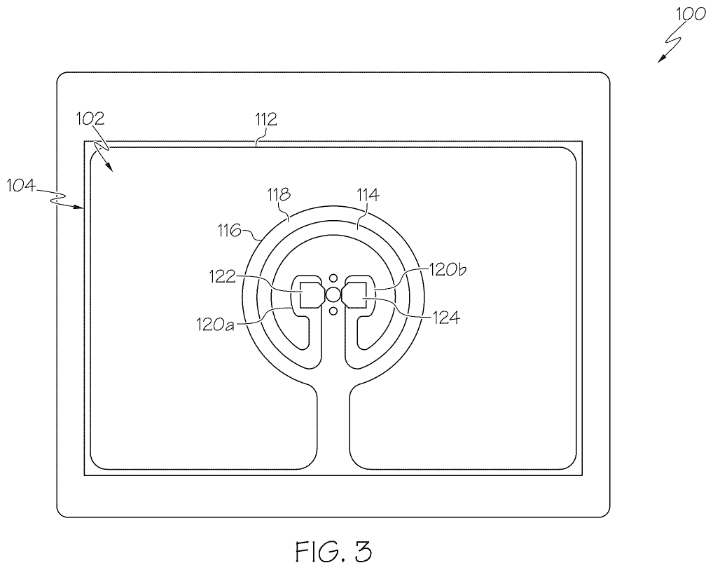

Turning now to FIG. 3, there is provided a wireless identification device 102 comprising an antenna 112 and impedance-matching loop 114. Wireless identification device 102 may be adhered or otherwise affixed to a functional layer 104. For purposes of the illustration, only one functional layer 104 is shown, but it should be understood that multiple functional layers may be used to form the wireless label construction 100. The wireless label construction 100 may be applied or attached to the package (not shown) containing the high-dielectric material. In some embodiments, the antenna 112 may create at least one directional sensitivity pattern configured to intersect with a read aperture of a RFID reader. The antenna 112 improves the read rate of the wireless identification device 102 when placed on packages containing high dielectric materials.

The gap between the antenna 112 and impedance-matching loop 114 may be in the range from 0.3 mm to 3 mm, e.g., from 0.4 mm to 2.5 mm or from 0.5 mm to 2.0 mm. Accordingly, the antenna 114 may define a curved inner edge 116 that forms an aperture 118 to surround at least a portion of the impedance-matching loop 114. In some embodiments, the aperture 118 has a maximum diameter (d) from 10 mm to 30 mm, e.g., from 12 mm to 26 mm or from 14 mm to 24 mm. Impedance-matching loop 114 comprises ends 120a, 120b that terminate within the impedance-matching loop 114. Impedance-matching loop 114 has a line width that may be between 0.3 mm and 3 mm, e.g., between 0.4 mm and 2.5 mm or between 0.5 mm and 2.0 mm. The wireless identification device 102 may have one or more straps 122 connecting the ends 120a, 120b to an integrated circuit (IC) chip 124. In some embodiments, the IC chip 124 may be a UHF RFID chip. It will be appreciated that a variety of strap configurations are available for coupling the IC chip 124 to the antenna 102. Examples include a strap 122 available from Alien Technologies, and the strap marketed under the name I-CONNECT, available from Philips Electronics. The strap 122 may be a material such as PET, polypropylene or other polyolefins, polycarbonate, or polysulfone.

In some embodiments, the perimeter of the antenna 112 may be from 130 mm to 160 mm, e.g., from 135 mm to 155 mm, from 140 mm to 150 mm. In some embodiments, the aspect ratio (the aspect ratio of the antenna may be calculated by dividing width (w) by height (h)) of the antenna 112 may be greater than 1.45, e.g., greater than 1.5, greater than 1.7, greater than 1.9 or greater than 2.0. In terms of ranges, the aspect ratio may be from 1.45 to 2.9, e.g., from 1.5 to 2.8, from 1.7 to 2.8 or from 1.9 to 2.6. In some embodiments, the impedance-matching loop 114 may have a maximum diameter ranging from 10 mm to 30 mm, e.g., from 12 mm to 26 mm or from 14 mm to 24 mm.

In some embodiments, the wireless identification device 102 may comprise a polymer layer. The antenna 112 and IC chip 124 may collectively form an inlay which may be mounted or attached to the polymer layer. In some embodiments, the polymer layer may be a biaxially oriented polypropylene (BOPP), which refers to a film or laminate that has been stretched in both the machine direction, and cross direction or traverse direction.

In some embodiments, the antenna may be a wide arm dipole antenna. Wide arm dipole antennas may have a solid construction with less than 20% of the area open, e.g., less than 15% of the area open. A solid antenna configuration has been found to strike a desirable balance between the electrical length and physical size of a wireless identification device. The wide arm dipole antennas may also achieve a high resonance frequency in free air while maintaining strong radiation efficiency when applied to high-permittivity protein products. In other embodiments, the antenna may be a hollow dipole antenna may have an open area of the antenna that is greater than 20%, and more preferably greater than 80% or even greater than 90%. Accordingly, hollow dipole antennas may be substantially devoid of conducting material. In such a configuration, the outer edge may be a conductive material that forms the antenna. This outer edge may be referred to as an antenna trace. In still further embodiments, the antenna structure is not limited to the embodiments shown in FIG. 3 and the wireless identification devices may include other types of antenna designs and configurations.

The antenna made be made from an electrically conductive material such as copper, aluminum, silver, carbon, platinum, gold, palladium, ruthenium, nickel, zinc and including alloys thereof as well as conductive inks. The conductive ink may include any suitable conductive material, for example, in some embodiments, the conductive ink includes at least one of a copper, silver, carbon, platinum, gold, palladium, ruthenium, nickel, zinc, an alloy of any of the foregoing, graphene or carbon nanotubes. Any suitable conductive ink, including commercially available conductive inks, may be used. The antenna may be formed by printing a conductive ink onto a carrier in the shape of an antenna. In some embodiments, a single sheet of metal such as, for example, aluminum sheet or foil may be cut to form the antenna used for the wireless identification device. The metal sheet may be cut using, for example, cutting methods or techniques such as die cutting, laser cutting, etching and so forth.

The label construction may include any suitable wireless identification device, several of which are readily commercially available. Wireless identification devices are well-known in the art. They include a conductive material that serves as an antenna for the device. When the conductive material is a conductive ink, after being laid down or printed, the conductive ink forms a printed object that is capable of conducting electricity. In some embodiments, the wireless identification device may be formed by printing a conductive ink onto the carrier, in the shape of an antenna. In some embodiments, the conductive material is etched onto the carrier. In some embodiments, the conductive material is adhered to the carrier. In some embodiments, the wireless identification device is adhered to a first adhesive, which may be a permanent adhesive. Any suitable adhesive may be used, such as for example an acrylic emulsion-based, acrylic solvent-based, acrylic hot melt, acrylic UV-based or rubber hot melt adhesive. In some embodiments, the first adhesive may be an acrylic emulsion-based adhesive. In some embodiments, the first adhesive is not a hot melt adhesive. In some embodiments, the first adhesive may be deposited on at least a portion of the carrier in the shape of an antenna. In some embodiments, the conductive material is deposited onto at least a portion of the surface of the first adhesive. In some embodiments, the conductive material that is deposited onto at least a portion of the surface of the first adhesive has the same, or substantially the same shape and size as the first adhesive. In some embodiments, the conductive material that is deposited onto at least a portion of the surface of the first adhesive has a larger size than the first adhesive. In some embodiments, the conductive material is die cut or laser cut, or both, so that the resulting conductive material has the same, or substantially the same shape and size as the underlying first adhesive. In some embodiments the conductive material is die cut. In some embodiments the conductive material is laser cut. It will be appreciated that other suitable means, for example, electroplating, may be used to form the antenna used for the wireless identification device.

In some embodiments, the wireless identification device includes only a conductive material that functions as an antenna. In some embodiments, the wireless identification device includes a conductive material connected to an integrated circuit or chip. In some embodiments, the integrated circuit is directly attached to the conductive material. In some embodiments, the wireless identification device further includes a strap. When a strap is used, rather than being coupled directly with the conductive material, the integrated circuit is coupled to strap leads, forming a strap that is then coupled to the conductive material, as is described, for example in U.S. Pat. No. 6,940,408B2, herein incorporated by reference.

### Functional Layer

### Functional Layer Properties

In some cases, any of the wireless label constructions disclosed herein may comprise a functional layer. The functional layer may be a low-loss, low-dielectric (e.g., 1-2 εᵣ) material that is positioned on one or both sides of the wireless identification device to create separation from high-dielectric materials. In many use cases, the functional layer may be deployed on both sides of the wireless identification device to maintain separation from both the package to which the wireless identification device is affixed, as well as to another package that may be placed on top of the wireless label constructions. The stacking of packages may be high in some cases, so the presence of a functional layer that increases readability has been found to be particularly useful in such situations.

As noted hereinabove, the disclosed functional layer converts from first state (“initial state”) to a second state (“final state”) upon application of a stimulus, preferably an external stimulus. For example, the change in the functional layer may be a change in at least one or more of the following: thickness, density; and/or dielectric constant. In some embodiments, the second thickness of the functional layer may, in some cases, be greater than the first thickness after expansion caused by the stimulus. Any suitable external stimulus may be used, so long as the stimulus elicits the desired response from the functional layer. In some embodiments, the external stimulus includes but is not limited to thermal, physical, radiation, electrical, sound, chemical, magnetic or any combination thereof. In some embodiments, the external stimulus may be a thermal stimulus, including but not limited to induction heating and IR (infra red) lamp. The external stimulus may also be a physical stimulus, including but not limited to pressure, vibrations, ultrasonication, and any combination thereof. The external stimulus may also be a radiation stimulus, including but are not limited to UV (ultra violet) radiation, laser radiation, electron beam radiation, electromagnetic radiation and any combination thereof.

The aforementioned changes result in improved readability of the wireless identification device. In some embodiments, the first state of the functional layer may be characterized by at least one of a first thickness in the range of 0.07 mm to 0.51 mm; a first density in the range of 0.2 g/cm³ to 1.1 g/cm³; and/or a first dielectric constant in the range of 2.6 to 4.3 @ 800 MHz. In some cases, the first state of the functional layer may be characterized by at least one of a first thickness in the range of 0.08 mm to 0.4 mm; a first density in the range of 0.3 g/cm³ to 1.05 g/cm³; and/or a first dielectric constant in the range of 2.6 to 4.0 @ 800 MHz. In some embodiments, the second state of the functional layer may be characterized by at least one of a second thickness in the range of 0.13 mm to 4.6 mm; a second density in the range of 0.03 g/cm³ to 0.5 g/cm³; and/or a second dielectric constant in the range of 1.4 to 3.3 @, 800 MHz. The material of the functional layer should expand without causing delamination or edge deformation in the second state, and thus the thickness should be less than or equal to 4.6 mm. In some cases, the second state of the functional layer may be characterized by at least one of a second thickness in the range of 0.3 mm to 2.5 mm; a second density in the range of 0.35 g/cm³ to 0.95 g/cm³; and/or a second dielectric constant in the range of 1.4 to 2.1 @ 800 MHz. A lower dielectric constant for the second state may be achieved, with the amount by which the dielectric state is lowered depending on the material of the functional layer.

It should be understood that the thickness as used herein refers to an average thickness. The thickness may be uniform in some embodiments, but before and after expansion. In general, after the expansion the thickness is non-uniform and an average thickness is representative.

In some cases, the conversion of the functional layer from a first state to a second state includes expansion in thickness and/or reduction in density. In some embodiments disclosed herein, for expansions occurring at temperatures between 80° C. to 120° C., a thickness expansion ratio of the second thickness of the functional layer to the first thickness of the functional layer may range from 0.1 to 35, e.g., 1.45 to 20, 3 to 18, and more preferably 5 to 15. The thickness expansion ratio is the thickness of the functional layer in the final state (second state) divided by thickness of the functional layer in the initial state (first state). In some embodiments, the second density of the functional layer may be lower than the first density.

One benefit from applying the stimulus is that the dielectric constant may be decreased. In some embodiments, the dielectric constant may drop from first state to second state by 5% to 50%, e.g., by 10% to 45% or by 15% to 45%. In some embodiments, the dielectric constant may drop constantly when the functional layer is expanded to a thickness of up to 1.33 mm and may continue to drop slowly or plateau with further increases of thickness. Accordingly the benefit of a decrease in the dielectric constant may be achievable with relatively small increases in thickness of the functional layer.

After application of the stimulus, the conversion may be resilient and may withstand compression forces typically found in stacked packages or articles. Depending on the material of the functional layer, after the stimulus has been applied, the second state may have a 15% to 41% compression at 40N force with a recovery of at least 65% to 99%. In some embodiments, the functional layer may preferably have a 17% to 38% compression at 40N force with a recovery of at least 75% to 95%.

The ability of the functional layer to have a lower thickness before exposure to an external stimulus is advantageous, as this enables the wireless label construction to be thin enough, before exposure to an external stimulus, to be printed on. Likewise, the ability of the functional layer to have a higher thickness after exposure to a stimulus is advantageous, as it enables the wireless label construction to be thick enough after exposure to a stimulus to create space between the wireless identification device and the surface to which it is applied. Furthermore, the ability of the functional layer to have a lower dielectric constant and/or a lower density after exposure to an external stimulus is advantageous, as it enables the reduction of the interference of the signal of wireless identification device.

In some embodiments, the wireless label construction includes one functional layer. In some embodiments, the wireless label construction includes one or more functional layers. In some embodiments, the wireless label construction includes two functional layers. In some embodiments, it is desirable to have more than one functional layer, for example where multiple articles on which the wireless label constructions are to be applied are to be stacked on top of each other, causing a heighted interference of the wireless signal.

### Functional Layer Materials

For purposes of the present disclosure, there are several suitable materials that may be used to form the functional layer. In some embodiments the functional layer may comprise an acrylic emulsion and a nonionic surfactant. When multiple functional layers are used, combinations of these materials may be used or the same material may be used for each of the functional layers. In addition, different materials for the functional layer may operate together to achieve the desired expansion upon the application of the stimulus. Each of the different materials may respond independently to the types of stimulus. Accordingly, the expansion of the wireless label construction may be controlled by using different types of different materials along with different types of stimulus.

In some embodiments, the functional layer may comprise an acrylic emulsion preferably comprising an alkyl acrylate and unsaturated carboxylic acid. The alkyl acrylates may contain about 4 to about 8 carbon atoms in the alkyl group. Useful alkyl acrylates include n-butyl acrylate, 2-ethylhexyl acrylate, isooctyl acrylate and the like, with 2-ethylhexyl acrylate and mixtures of 2-ethylhexyl acrylate and butyl acrylate being preferred.

The functional layer may also comprise an unsaturated carboxylic acid containing from 3 to about 5 carbon atoms. Unsaturated carboxylic acid, included among others acrylic acid, methacrylic acid, itaconic acid and the like. Acrylic acid and methacrylic acid or mixtures thereof are presently preferred.

In some embodiments, the acrylic emulsion may comprise a vinyl ester. The vinyl ester may contain from 2 to about 16 carbon atoms in the alkyl chain of the ester. Vinyl esters may include vinyl acetate, vinyl butyrate, vinyl propanate, vinyl isobutarate and the like.

In some embodiments, the acrylic emulsion may comprise a dicarboxylic acid or diester thereof, which may include such as di-2-ethylhexyl maleate and di-2-ethylhexyl fumarate and the like. In some embodiments, the alkyl group of the dicarboxylic acid or diester may independently contains from about 6 to about 16 carbon atoms, preferably from about 6 to about 12, carbon atoms.

In some embodiments, the acrylic emulsion comprises from 30 to 98% of an alkyl acrylate, based on the dry weight of the functional layer, e.g. preferably from 35 to 95%, or more preferably from 40 to 85%, 1 to 10% of an unsaturated carboxylic acid, e.g. preferably from 1.5 to 8%, or more preferably from 1.5 to 5%, from 0 to 30% of a vinyl ester, e.g. preferably from 15 to 30%, or more preferably from 20 to 25%, and from 0 to 40% of a dicarboxylic acid, preferably from 10 to 40%, or more preferably from 15 to 35%.

In some embodiments, the acrylic emulsion may comprise a crosslinker, such as polyfunctional acrylates, aziridine, acrylamide, isocyanates, hydrogen functional siloxane crosslinkers, melamine-formaldehyde resins, or epoxy resins. The polyfunctional acrylates may include diallyl maleate (DAM), allyl methacrylate (AMA), pentaerythritol tetraacrylate (PETA) or ethylene glycol dimethacrylate (EGDMA). Zinc acetate may also be used as a crosslinker. N,N′-methylene-bis-acrylamide is another suitable crosslinker that may be used with acrylic emulsions. In some embodiments, the acrylic emulsion may be self-crosslinking system comprising diacetone acrylamide (DAAM) and with adipic acid dihydrazide.

In some embodiment, the acrylic emulsion may comprise a nonionic surfactant. In some embodiments, functional layers may comprises from 0.4% to 5% by weight of the nonionic surfactant, based on the dry weight of the functional layer, preferably from 0.5% to 3.5% or more preferably from 0.7% to 3%. The nonionic surfactant may comprise alcohol ethoxylates (linear or branch), alkylphenol ethoxylates, alkyl polyglucosides, acetylenic diols, multifunctional block copolymers, tristyrylphenol ethoxylates, polyvinyl alcohol, tristyrylphenol ethoxylates, and mixtures thereof. One suitable multifunctional block copolymer surfactant includes a polyoxypropylene-polyoxethylene block copolymer, commercially available as Pluronic F-108 (BASF). Nonionic emulsified waxes may also be used.

Acrylic emulsions with an anionic surfactant stabilizers caused incompatibility, destabilizing the expandable particles and leading to poor or no expansion. The presence of an anionic surfactant stabilizer leads to incompatibility, destabilizing the expandable particles, and in particular those having a gaseous core. This destabilization causes the loss of active ingredient (isobutane or isopentane) from the particle core, resulting in coatings that exhibit poor or no expansion. Accordingly, it is preferred to limit the amount of anionic surfactants and in some embodiments, the anionic surfactant may be less than 0.5% anionic surfactants, based on the dry weight of the functional layer.

In some embodiments, the acrylic emulsions exclude polyfunctional alcohols, polyoxyalkylenes or polyoxyalkylene derivatives. Accordingly, the acrylic emulsion may contain less than 0.5% of polyfunctional alcohols, polyoxyalkylenes or polyoxyalkylene derivatives, based on the dry weight of the functional layer, and preferably contains substantially no amount of polyfunctional alcohols, polyoxyalkylenes or polyoxyalkylene derivatives. The polyfunctional alcohols, polyoxyalkylenes or polyoxyalkylene derivatives may include glycerol, dibenzoates such as diethylene glycol dibenzoate and dipropylene glycol dibenzoate, polyethylene glycol, polyethylene glycol monomethyl ether, polyethylene glycol monoethyl ether, polyethylene glycol dimethyl ether, polyethylene glycol diethyl ether, polypropylene glycol, polybutylene glycol or their copolymers or any combination thereof. The presence of such components has been found to be contribute to de-anchorage of the functional layer and deteriorates the long-term aging. To maintain effective performance, in some embodiments, the polyfunctional alcohols, polyoxyalkylenes or polyoxyalkylene derivatives may be excluded from the acrylic emulsion.

In some embodiments, the acrylic emulsion polymer may be a crosslinked acrylic polymer containing butyl acrylate, 2-ethylhexyl acrylate and an unsaturated carboxylic acid. The acrylic polymer may contains 2-ethyl hexyl acrylate, vinyl acetate, weight di-2-ethyl hexyl maleate, acrylic acid, and methacrylic acid and are formed as an emulsion.

The acrylic polymers may be prepared by emulsion polymerization in the presence of one or more nonionic surfactants, which when reacted becomes part of the polymer. The acrylic polymer may be used as formed and, if desired, crosslinked either during or following polymerization and are provided as emulsion of the solids content from 38% to 60%, e.g., from 40% to 55% or from 44 to 54%.

In accordance with some embodiments, the conversion of the functional layer from a first state to a second state includes a physical expansion. The functional layer may include expandable particles, such that the particles are adapted to expand upon the application of an external stimulus to the wireless label construction. The particles may adapted to increase the thickness of the functional layer and reduce the density of the functional layer. In accordance with some embodiments, the expandable particles may be disposed on the functional layer. In accordance with some embodiments, the expandable particles may be dispersed in the functional layer.

In some embodiments, the expandable particles may include a core and a polymeric shell. The core may contain hydrocarbons including but not limited to isobutane, isopentane, or other suitable blowing agents. The polymeric shell may be made of polymers including but not limited to vinylidene chloride-acrylonitrile copolymers, polyvinyl alcohols, polyvinyl butyrals, polymethyl methacrylates, polyacrylonitriles, polyvinylidene chlorides, polysulfones, or combinations thereof.

In preferred embodiments, the expandable particles are thermally expandable particles. In accordance with some embodiments the particles are activatable at temperatures in the range of 50° C. to 200° C., preferably 60° C. to 100° C.

The functional layer may also contain additives such as for example thermally conductive particles or magnetic materials to enhance expansion or wireless performance. In some embodiments, the functional layer may comprise fillers depending on cost and film strength.

In accordance with some embodiments, a diameter of the particles prior to expansion can be in the range of 5 μm to 50 μm. In accordance with some embodiments, a diameter of the particles after expansion can be in the range of 20 μm to 200 μm.

The functional layer comprising expandable particles serves to create separation between the wireless identification device and the object to which the label is applied, particularly when that object has properties that could interfere with the performance of the wireless device. The expandable particles allow the functional layer to increase in thickness when activated, thereby increasing this separation distance.

### Wireless Label Constructions

The wireless label construction comprises at least one functional layer and wireless identification device. In some embodiments, the wireless label construction may include additional layers or non-functional layers. The wireless label construction may further include additional layers such as a one or more face layers, polymeric films, adhesive layers, non-functional layers, release liners, or any combination thereof. In some embodiments, these additional layers may be designed to work in conjunction with the functional layer, allowing for proper expansion while maintaining the integrity and functionality of the label. Accordingly, the additional layers may act to encapsulate the functional layer to prevent delamination or edge deformation. Thus, the expanded functional layer and any gases generated therein are not released, but may be retained within the wireless label construction.

In some embodiments, the face layer and/or polymeric film may be disposed on at least one of the first surface and the second surface of the functional layer. In some embodiments, the face layer and/or polymeric film may have a printable surface. The opposing surface of the face layer and/or polymeric film may be an adhesive surface. The polymeric film may be made up of a polymer selected from polyolefin, polyester, polyurethane, polyamide, a polyvinyl chloride, a polyacrylate, an acrylonitrile rubber, polycarbonate, or any combination thereof.

The non-functional layer may be for example, a topcoat, an adhesive, a primer, ink layer or any combination thereof. In some embodiments, the non-functional layer is disposed on at least one of the first surface and the second surface of the wireless identification device; and between the wireless identification device and the functional layer. In some embodiments, the non-functional layer or layers may be disposed on at least one of the first surface and the second surface of the functional layer; and between the functional layer and the polymeric film. In some embodiments, the functional layer and the non-functional layer independently comprise an additive. The additives preferably may be selected from thermally conductive particles, magnetic materials, gas-absorbing particles, gas-encapsulating particles, expansion promoters, or any combination thereof. Alternatively, the additive may be selected from metal oxides, graphite, carbon black, carbon nanotubes, carbon nano-sheets, silicon carbide, magnetic alloys, zeolites, clay, cyclodextrins, or any combination thereof.

The various wireless label constructions disclosed herein allows the wireless identification device, in particular the RFID device, to be used effectively on metal, liquid-containing, and other high-dielectric objects that would normally interfere with the wireless identification device's operation. In some embodiments, the functional layer creates an air gap or low-dielectric region to improve readability without requiring thick, pre-expanded labels that are difficult to print on and apply. The wireless label construction may be designed for use in various environments and applications. For example, it may be engineered to withstand high temperatures, aging, low temperatures, humidity, and/or chemical exposure. The materials used in the construction may be selected for compatibility with food contact, medical applications, or other specialized uses.

The wireless label construction may be provided in various formats, such as individual labels, continuous rolls, or sheets. In some embodiments, the wireless label construction may be compatible with various printing and encoding technologies, including thermal transfer, direct thermal, inkjet, or laser printing.

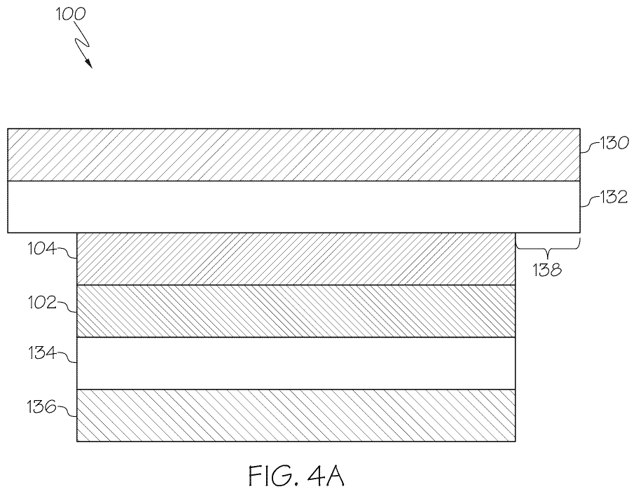

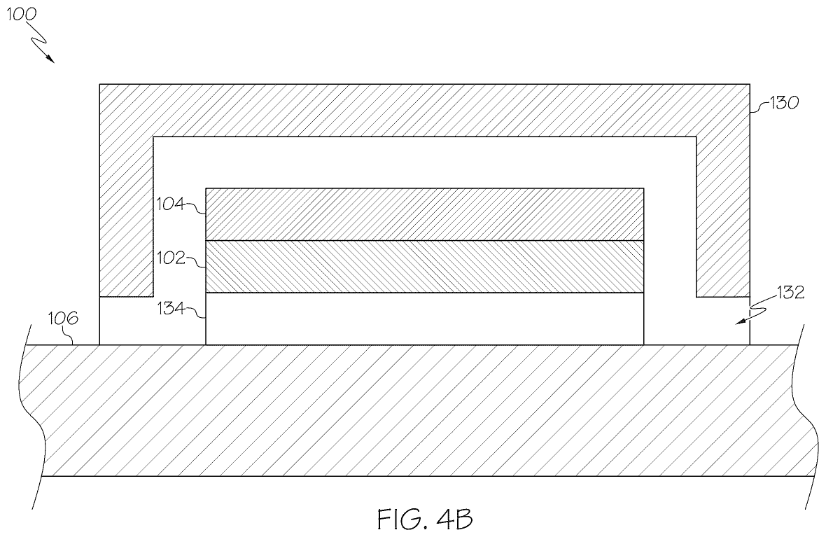

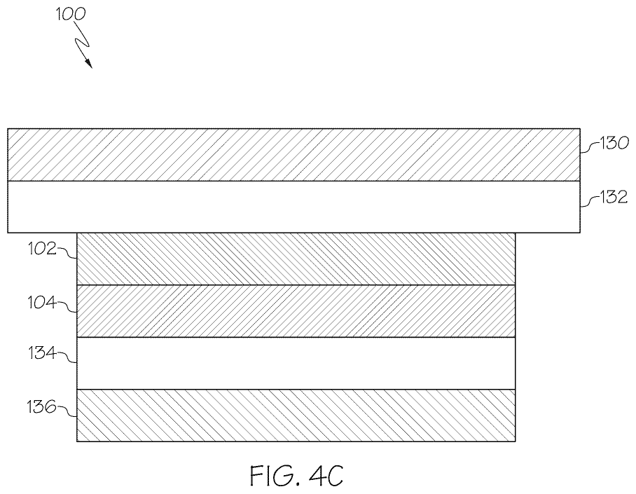

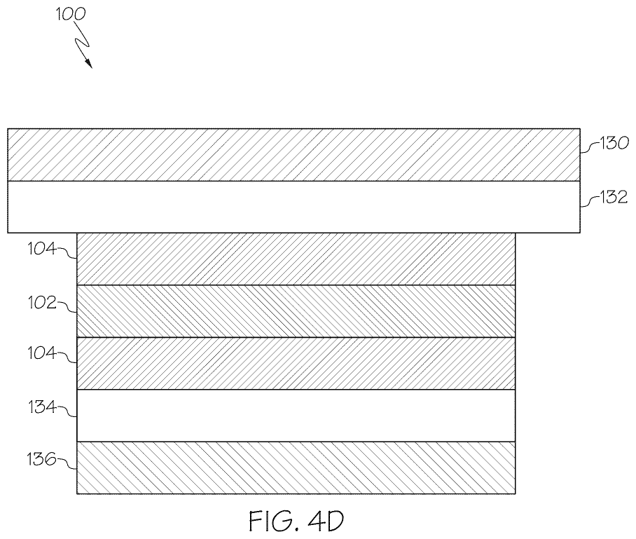

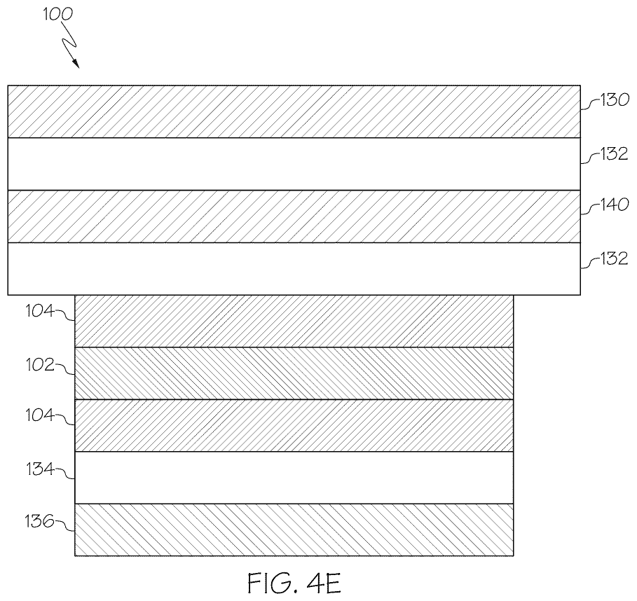

FIGS. 4A-4D illustrates an exemplary embodiment of a side view of a wireless label construction 100 according to embodiments of the disclosure. The wireless label construction 100 includes a functional layer 104, wherein the functional layer may be a topcoat comprising expandable particles or other suitable materials described herein for a functional layer, and a wireless identification device 102. The wireless label construction 100 further includes several non-functional layers. As shown in FIG. 4A there is provided a face layer 130, adhesive layers 132/134, and release liner 136. In some embodiments, the adhesive layers 132/134 may be a pressure-sensitive adhesive and each layer of adhesive may be made of a similar material. The face layer 130 may have adhesive layer 132 coated on the surface of the face layer 130 or may be coated in a pattern such as stripped or dot pattern. This may form an adhesive surface on the face layer 130. In some embodiments, the face layer 130 and adhesive layer 132 may be laminated together and then attached to either the functional layer 104 or wireless identification device 102.

The release liner 136 may be paper such as kraft or glassine, or polymeric film such as PET or polyolefin. The release liner 136 may be applied during the manufacturing process, used to prevent a surface from prematurely adhering to a wireless label construction 100. In some embodiments, the release liner may be coated on one or both sides with a release agent, which provides a release effect against any type of sticky material, such as an adhesive or a mastic. The release agent may be applied a coating level of 0.5-3 grams per square meter (gsm).

In some embodiments, the area of the functional layer 104 may be less than the area of the face layer 130. In addition, the area of the wireless identification device 102 may be less than the area of the face layer 130. This allows the face layer 130 to extend in at least two directions, preferably in each direction, from the wireless identification device 102 to encapsulate the functional layer 104. Preferably the face layer 130 extends in each direction by at least 3 mm, e.g., at least 3.5 mm, at least 4 mm, at least 4.5 mm, at least 5 mm or at least 10 mm. When the extension is less than 3 mm, it becomes difficult to achieve the desired expansion without increasing the risk of delamination. In terms of ranges the face layer 130 may extend by at least 3 mm to 20 mm, e.g., from 3.1 mm to 15 mm, from 3.1 mm to 12 mm or from 3.5 mm to 10 mm. Each side of the extension may be a different in terms of length within the disclosed ranges. The amount of the extension may be determined by the overall size of the wireless identification device 102. To prevent excess material, the extension is generally 20 mm or less. The extension creates an overhang 138 in FIG. 4A that formed the encapsulation shown in FIG. 4B when applied to the package 106. As functional layer 104 is stimulated to the second state, there may be gases that are released. To achieve the expansion the gases may be retained or trapped with the wireless label construction 100. Encapsulated the functional layer 104 using the face layer 130 is effective to prevent delamination or edge deformation that may be caused by a gas release from the function layer 104.

In FIG. 4B, the wireless label construction 100 may be bonded to the substrate of a package 106, which is not a part of the construction, by removing release liner 136. In some embodiments, the package may be a molded article. When encapsulated with the face layer 130, both adhesives 132/134 may be used to adhere the wireless label construction 100 to the package 106. The adhesives 132/134 may be removable to allow the wireless label construction 100 to be removed as needed.

Suitable materials for the face layer 130 include, but are not limited to, metal foils, polymer films, paper, and combinations thereof. The materials may be textiles including woven and non-woven fabrics made of natural or synthetic fibers. The materials may be single-layered paper or film or the materials may be multi-layered constructions. The multi-layered constructions or multi-layered polymeric films can have two or more layers, which may be joined by coextrusion, lamination, or other processes. The layers of such multi-layered constructions or multi-layered polymeric films can have the same composition and/or size or can have different compositions or sizes. Preferably, the face layer 130 may be flexible. In some embodiments, the face layer may have coatweight from 10 to 300 gsm, e.g., from 30 gsm to 250 gsm, or from 80 gsm to 200 gsm.

In some embodiments, the adhesives used in the wireless label constructions may be pressure sensitive adhesive. The pressure sensitive adhesive may be one of any number of different types of adhesives, such as acrylic and elastomeric pressure sensitive adhesives or water-activated adhesives. The adhesive may be of the sort that is removable so that the label may be removed from the substrate after it is applied thereto, or the adhesive may be a permanent type of adhesive for permanently bonding the label to the substrate. Alternatively, the adhesive may be repositionable, so that the label may be repositioned on the substrate after it is initially applied. In some embodiments, the adhesive may be a permanent pressure sensitive adhesive or a laminating adhesive. In some embodiments, when the face layer or other polymeric film is to be printed in a printer that generates high heat, such as a laser printer, the adhesives may be temperature stable. Each adhesive layer may have a different coatweight and in some embodiments, the coatweight of the adhesive layers may independently be from 5 gsm to 30 gsm, e.g., from 7 gsm to 25 gsm or from 10 to 20 gsm.

In FIG. 4A, the functional layer 104 is positioned between the face layer 130 and wireless identification device 102. In other embodiments, the functional layer 104 may be positioned one surface of the wireless identification device 102 opposing the face layer 130 as shown in FIG. 4C. In still further embodiments, the wireless label constructions 100 may include one or more functional layers 102 as shown in FIG. 4D. As shown in FIG. 4D, the functional layers 104 may be placed on either side of the wireless identification device 102. Each functional layer 104 may be the same type of material that responds in a similar manner to the stimulus. In other embodiments, the materials of the functional layer 104 may be different to allow the expansion of the functional layers to be controllable.

In FIG. 4E, there is provided an additional polymeric film 140 that is provided in the wireless label construction 100. Although one polymeric film 140 is shown in FIG. 4E, the wireless label construction 100 may include multiple layers of polymeric films. The polymeric films may be placed at any location within the wireless label construction 100 and in some embodiments may be printed. In some embodiments, when a polymeric film 140 is used it is useful to add adhesive layers on either side of the polymeric film 140. The polymeric film 140 may be used to provide the wireless label construction 100 with structural stability. In some embodiments, the polymeric film 140 may also be used to provide further encapsulation of the functional layer 104. Accordingly, the polymeric film may be extend in at least two directions, preferably in each direction, similar to the face layer 130.

### Wireless Label Construction Methods

In other aspects the present disclosure provides a method of manufacturing the wireless label construction. The wireless label construction may be manufactured using various techniques. The method of manufacturing a wireless label construction may include the steps of coating a functional layer on a face layer and/or polymeric film and subsequent drying; providing a wireless identification device, adhering the coated functional layer to at least one surface of the wireless identification device. The method can also include the step of coating a non-functional layer, i.e. adhesive, on the wireless label construction. The method may further include the step of applying a face layer and/or polymeric film to the wireless label construction, followed by printing indicia on the face layer and/or polymeric film of the wireless label construction prior to applying the external stimulus.

In some embodiments, the functional layer 104 may be applied to the wireless identification device 102 by coating one surface. In other embodiments, the functional layer 104 may be applied in a pattern or dot configuration. This may allow for expansion between the areas functional layer which may further act to encapsulate any gases released from the functional layer.

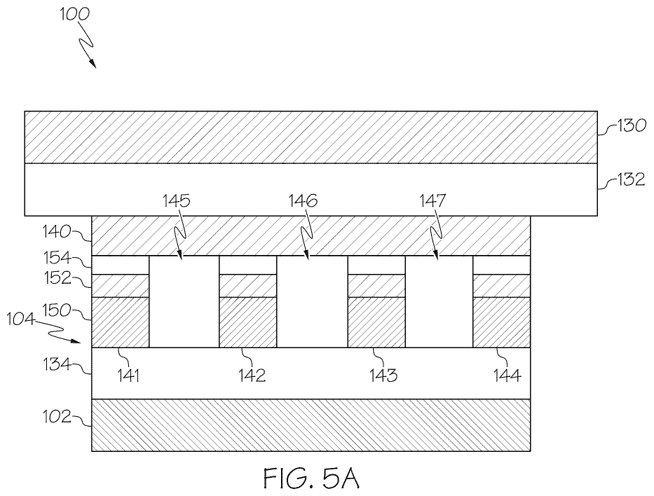

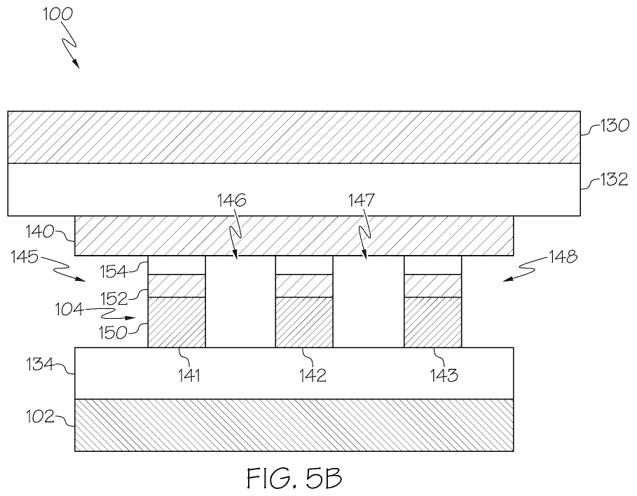

Turning now to FIGS. 5A and 5B, there is provided a functional layer 104 having functional lanes 141-144 of functional materials as described herein and zones 145-148 of no material to separate functional lanes. The number of functional lanes is not limited in the various patterns, but may be dependent on the overall configuration of the wireless label construction 100. In some embodiments, the number of lanes may be from 2 to 24 lanes, e.g., from 2 to 22 lanes, from 2 to 18 lanes from 2 to 8 lanes or from 2 to 5 lanes. Correspondingly, the number of zones may be from 2 to 12 lanes, e.g., from 2 to 8 lanes or from 2 to 5 lanes. In FIG. 5A there are shown 4 functional lanes and 3 zones, while FIG. 5B shows 3 functional lanes and 4 zones. By using a pattern such as the functional lanes shown in FIGS. 5A and 5B the wireless label construction 100 may achieve the desired changes to the second state with lower coat weight, including lower cost weights of the adhesive, and thereby reduce costs. In addition, the zones 145-148 of no material may further assist in preventing delamination. In some embodiments, the gases released from the functional lanes 141-144 may trapped partially or entirely within the adjacent zones 145-148.

As shown in FIGS. 5A and 5B, each lane 141-144, comprises a functional section 150, a polymeric film section 152 and an adhesive section 154. Instead of the lanes 141-144, being applied directly to the wireless identification device 102, there may be an intervening adhesive layer 134. In addition, the face layer 130 is separated from the lanes 141-144 by an polymeric film 140. Incorporating the overlaminate of the polymeric film 140 may further create pockets to trap gas released by the functional layer 104. Although lanes are shown on one side of the wireless identification device 102, there may be functional lanes on either side, including both sides.

In some embodiments, each of the functional lanes may independently have a width that is from 1.3 mm to 20 mm, e.g., from 1.5 mm to 18 mm, from 1.6 mm to 15 mm, or from 6 mm to 13 mm. In some embodiments, the functional lanes may be substantially uniform widths. In other embodiments, the widths may vary. For examples the outer most lanes may be wider than the inner most lanes.

In some embodiments, each of the non-functional zone may independently have a width that is from 1 mm to 10 mm, e.g., from 1 mm to 8 mm, or from 1 mm to 6 mm. These non-functional zones may have a similar width as the functional lanes. Preferably the non-functional zones may be narrower than the functional lanes. In some embodiments, the non-functional zones do not have any material from the functional layer, but may include adhesives or polymeric films.

In still further aspect, the embodiments disclosed herein provide a method of use of the wireless identification device. The method of enhancing the wireless readability of a wireless identification device on an article having a high dielectric constant may include the steps of providing an article having a high dielectric constant; applying a wireless label construction according to the various embodiments described herein comprising a wireless identification device having a first surface and a second surface, at least one functional layer having a first surface and, a second surface and an initial state, wherein the functional layer is disposed on at least one of the first surface and the second surface of the wireless identification device; and wherein the functional layer is capable of being converted from an initial state to a final state upon application of an external stimulus. Optionally, a face layer and/or polymeric film may be disposed on at least one of the first surface and the second surface of the functional layer; and further, a non-functional layer may be disposed on at least one of the wireless identification device and the functional layer. The functional layer may be converted from an initial state to a final state in response to the external stimulus. In some embodiments, the wireless label construction is applied to an article having a high dielectric constant prior to applying the external stimulus. In some other embodiments, the wireless label construction is applied to an article having a high dielectric constant after applying the external stimulus.

The expanded functional layer may provide additional benefits beyond improving wireless performance. For example, it may offer cushioning or impact resistance to protect the wireless device or the object it is applied to. In some implementations, the expanded layer may provide thermal insulation or act as a moisture barrier.

### EXAMPLES

### Examples 1-17: Functional Layer Compositions

A functional layer were developed by combining acrylic emulsion pressure sensitive adhesive with Expancel 031 DU40. The acrylic emulsion pressure sensitive adhesive is a crosslinked acrylic polymer containing butyl acrylate, 2-ethylhexyl acrylate and an unsaturated carboxylic acid having a nonionic surfactant, and solids contains 53.85% w/w of polymer. Expancel® 031 DU40 is commercially available from Nouryon (Tₛₜₐᵣₜ=80-95° C., Tₘₐₓ=118-133° C., density=≤12 kg/m³, particle size D(0.5)=10-16 μm). Expancel® 031 DU40 has a poly(methyl methacrylate)-co-poly(acrylonitrile) (PMMA-co-PAN) polymeric shell with an isobutane gas. The compositions shown in Table 1 were mixed with an overhead mixture (Caframo®) at 900 rpm for 10 minutes with water or an aqueous composition of 5.5 wt % PVOH. An aziridine crosslinker was used in some of the compositions and mixed with the water prior to the addition of the Expancel particle. Each composition was then coated onto a 0.051 mm polyethylene terephthalate (PET) film with a bullnose coater. The mixtures were then dried in a convection oven at 80° C. for 10 minutes to form a functional layer.

TABLE 1

| | Expancel | Acrylic | | | 5.5 wt % | | Total | |
|---|---|---|---|---|---|---|---|---|
| Example | 031DU40 | emulsions | | Water | PVOH | Crosslinker | solids | |
| Example 1 | 2 g | 5.66 | g | 3 g | | | 46.9 | wt % |
| Example 2 | 3 g | 11.32 | g | 2 g | | | 55 | wt % |
| Example 3 | 3 g | 5.66 | g | 3 g | | | 52 | wt % |
| Example 4 | 3 g | 5.66 | g | 1 g | | | 62 | wt % |
| Example 5 | 3 g | 5.66 | g | — | 3 g | | 52 | wt % |
| Example 6 | 3 g | 5.66 | g | 3 g | | | 53 | wt % |
| Example 7 | 3 g | 5.66 | g | 2 g | | | 55 | wt % |
| Example 8 | 3 g | 5.66 | g | 5 g | | | 44 | wt % |
| Example 9 | 3 g | 5.66 | g | 7 g | | | 38 | wt % |
| Example 10 | 3 g | 5.66 | g | 1 g | 3 g | | 48.7 | wt % |
| Example 11 | 3 g | 5.66 | g | 2 g | 2 g | | 48.3 | wt % |
| Example 12 | 3 g | 5.66 | g | 3 g | 1 g | | 47.8 | wt % |
| Example 13 | 3 g | 5.66 | g | 4 g | | | 47.4 | wt % |
| Example 14 | 6 g | 11.32 | g | 8 g | | — | 47.2 | wt % |
| Example 15 | 6 g | 11.32 | g | 8 g | | 35.7 mg | 47.3 | wt % |
| Example 16 | 6 g | 11.32 | g | 8 g | | 17.9 mg | 47.2 | wt % |
| Example 17 | 6 g | 11.32 | g | 8 g | | 71.4 mg | 47.4 | wt % |

### Examples 18-32: Expansion Testing

The functional layers from Table 1 were tested on a construction having a PET/adhesive/PET/functional layer/adhesive/PET and tested when expanded at 90° C. for 10 minutes. The coatweight (gsm) of the functional layer is indicated in Table 2. Each functional layer was tested at least three times and the average results are reported in Table 2. The thickness of the functional layer is reported in mm.

TABLE 2

| | | | Thickness | Thickness |
|---|---|---|---|---|
| | | Functional | before | after |
| | Functional | Layer | expansion | expansion |
| Example | Layer | Coatweight | (mm) | (mm) |
| 18 | Example 1 | 16.3 gsm | 0.191 | 0.567 |
| 19 | Example 2 | 16.5 gsm | 0.191 | 0.489 |
| 20 | Example 3 | 16.9 gsm | 0.203 | 0.699 |
| 21 | Example 3 | 17.6 gsm | 0.203 | 0.677 |
| 22 | Example 3 | 27.6 gsm | 0.216 | 1.041 |
| 23 | Example 4 | 21.7 gsm | 0.216 | 1.041 |
| 24 | Example 5 | 20 gsm | 0.210 | 0.873 |
| 25 | Example 6 | 17 gsm | 0.197 | 0.860 |
| 26 | Example 8 | 16.4 gsm | 0.194 | 0.768 |
| 27 | Example 12 | 24 gsm | 0.216 | 0.930 |
| 28 | Example 13 | 23.1 gsm | 0.213 | 0.857 |
| 29 | Example 14 | 17.6 gsm | 0.191 | 0.746 |
| 30 | Example 15 | 18.3 gsm | 0.191 | 0.781 |
| 31 | Example 16 | 19.4 gsm | 0.194 | 0.772 |
| 32 | Example 17 | 19.1 gsm | 0.194 | 0.781 |

Example 18-32 demonstrated performance as functional layer to respond to a stimulus during expansion.

Examples 6 and 7 resulted in thick, viscous mixtures upon coating, which frequently led to streaked coatings. The solids content was reduced in Example 8 to allow for coating. Regardless of the coating issues, both examples demonstrated improved expansion in Examples 25 and 26. However, a limit was observed, as excessive water addition, such as in Example 9, resulted in foaming.

“Examples 10 and 11 consists of formulations with an additional component primarily 5.5 wt % PVOH and the compositions were too thick to be successfully coated. As the PVOH is reduced in Example 12, the composition was able to be successfully coated and demonstrated improved expansion in Example 27.

Examples 30-32 show the addition of increasing amount of aziridine crosslinker, relative to the uncrosslinked formulation in Example 29, does not influence the final expansion despite the increase in the elastic modulus. This is advantageous because incorporating crosslinkers improves shear stability and long-term aging performance.

### Examples 33-36: Aging

The functional layers from Examples 14-17 were tested under aging conditions (50° C./80% RH) and reported in Table 3. The unaged sample can be found in Table 2 above, in examples 29-32 and in comparing the examples, these functional layers maintained stability.

TABLE 3

| | | | Thickness | Thickness |
|---|---|---|---|---|
| | | Functional | before | after |
| | Functional | Layer | expansion | expansion |
| Example | Layer | Coatweight | (mm) | (mm) |
| 33 | Example 14 | 18.4 gsm | 0.200 | 0.740 |
| 34 | Example 15 | 18.3 gsm | 0.195 | 0.762 |
| 35 | Example 16 | 19.4 gsm | 0.203 | 0.822 |
| 36 | Example 17 | 19.1 gsm | 0.203 | 0.759 |

The low Tg of polymer matrix for examples 14-17 provided the necessary tack for adhesion to the film surface. Moreover, the high entanglement and inherent hydrophobicity of the acrylic emulsion imparted resistance to humidity and long-term aging, ensuring particle expansion performance comparable to that of unaged coatings.

### Examples 37-43: Carrier-Free Expandable Film

Functional layer were developed by combining acrylic emulsion pressure sensitive adhesive with Expancel 031 DU40, as described in Examples 1-17. The compositions shown in Table 4 were mixed with an overhead mixture (Caframo®) at 900 rpm for 10 minutes with water. An aziridine crosslinker was used in some of the compositions and mixed with the water prior to the addition of the Expancel particle. Each composition was then coated onto a 0.051 mm siliconized polyethylene terephthalate (PET) film release carrier polyethylene terephthalate (PET) film with a bullnose coater. The mixtures were then dried in a convection oven at 80° C. for 10 minutes to form a functional layer.

TABLE 4

| | | Expancel | | |
|---|---|---|---|---|
| | Emulsion mass | 031DU40 | Water | Crosslinker |
| Example | (g) | (g) | (g) | (g) |
| Example 37 | 11.32 | 6 | 8 | 0 |
| Example 38 | 11.32 | 1.5 | 2 | — |
| Example 39 | 11.32 | 3 | 4 | — |
| Example 40 | 11.32 | 1.5 | 1 | — |
| Example 41 | 11.32 | 3 | 2 | — |
| Example 42 | 11.32 | 4 | 6 | 0.568 |
| Example 43 | 11.32 | 6 | 8 | 0.143 |

Tensile properties of Examples 37, 39, 43, all coated on 2 mil PET release carriers at the coatweights listed in Tables 5 and 6, were determined via tensile tests. These measurements were conducted using an MTS system according to D882-Tensile Testing of Thin Plastic Film, with samples prepared as dog bones. The crosshead speed was set at 12 inch/min, and data was acquired at a rate of 10 Hz. The width of each of the coatings was 12.7

TABLE 5

| | | | Peak | Tear | T = | % Elongation |
|---|---|---|---|---|---|---|
| | Coatweight | Thickness | Load | Energy | UTS | @ Break |
| Ex. | gsm | mm | Pa | N*mm | kPa | % |
| 37 | 56 gsm | 2.50 | 4.8 | 41.8 | 6.9 | 112.77 |
| 39 | 56 gsm | 3.17 | 6.2 | 141.2 | 648.1 | 307.70 |
| 43 | 63.6 gsm | 3.17 | 9.5 | 20.3 | 859.6 | 32.33 |

TABLE 6

| | | Yield | % Strain | | |
|---|---|---|---|---|---|
| | TEA | Stress | @ Yield | Modulus | Break Load |
| Ex. | in*lbf/in\hat{ }2 | kPa | % | MPa | N |
| 37 | 0.21 | 581.7 | 39.20 | 1.19 | 0.58 |
| 39 | 0.71 | 298.1 | 37.93 | — | 0.67 |
| 43 | 0.10 | 503.1 | 9.03 | 6.23 | 0.84 |

Analysis of the data in Tables 5 and 6 reveals a relationship between particle content and material ductility. Specifically, reducing the particle content from Example 37 to Example 39, while maintaining identical coatweights, led to a more ductile material (Example 39). This change was evidenced by higher percentage of elongation at break and increased tear fracture energy. Conversely, the inclusion of a crosslinker in Example 43 resulted in higher Ultimate Tensile Strength (UTS) but rendered the material more brittle, as indicated by a lower percentage of elongation at break.

### Examples 44-54: Expansion Testing

The functional layers from Table 4 were tested on a construction having a PET/adhesive//functional layer PET and tested when expanded at 90° C. for 10 minutes. The coatweight (gsm) of the functional layer is indicated in Table 8. Each functional layer was tested at least three times and the average results are reported in Table 8. The thickness of the functional layer is reported in mm.

TABLE 8

| | | | Thickness | Thickness |
|---|---|---|---|---|
| | | Functional | before | after |
| | Functional | Layer | expansion | expansion |
| Example | Layer | Coatweight | (mm) | (mm) |
| 44 | 37 | 68.6 gsm | 0.216 | 0.744 |
| 45 | 39 | 69.2 gsm | 0.216 | 1.072 |
| 46 | 43 | 23.6 gsm | 0.145 | 0.538 |
| 47 | 43 | 14.4 gsm | 0.140 | 0.411 |
| 48 | 43 | 63.6 gsm | 0.203 | 1.397 |
| 49 | 42 | 21.6 gsm | 0.147 | 0.361 |
| 50 | 42 | 14.8 gsm | 0.140 | 0.262 |
| 51 | 40 | 19.6 gsm | 0.140 | 0.224 |
| 52 | 40 | 42.8 gsm | 0.178 | 0.411 |
| 53 | 40 | 65.2 gsm | 0.216 | 0.792 |
| 54 | 39 | 56 gsm | 0.198 | 0.876 |

The data provided in the table 7 indicates a trend where increased coat weights and higher particle content generally result in greater final expanded thickness for both crosslinked and uncrosslinked materials. In addition, the incorporation of the expanded particles along with the introduction of crosslinking leads to a noticeable rise in the elastic modulus and a reduction in viscous behavior at the glass transition temperature (Tg) across all polymers tested.

A number of implementations have been described. Nevertheless, it will be understood that various modifications may be made without departing from the spirit and scope of the disclosure. Accordingly, other implementations are within the scope of the following claims.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims.

What is claimed is:

1. A wireless label construction comprising:
a face layer having a printable surface and an adhesive surface, wherein the printable surface opposes the adhesive surface;
a wireless identification device;
an adhesive layer, wherein the wireless identification device is positioned between the face layer and the adhesive layer; and
one or more functional layers, each of the functional layers comprising an expandable component, and the one or more functional layers are positioned between the face layer and the wireless identification device, and/or between the adhesive layer and the wireless identification device,
wherein at least one of the one or more functional layers comprises an acrylic emulsion, a nonionic surfactant, and expandable particles wherein the expandable particles comprising a core and a polymeric shell.

2. The wireless label construction of claim 1, wherein the at least one of the one or more functional layers comprises from 0.4% to 5% by weight of the nonionic surfactant, based on the dry weight of the functional layer.

3. The wireless label construction of claim 1, wherein the nonionic surfactant comprises a multifunctional block copolymer surfactant.

4. The wireless label construction of claim 1, wherein the at least one of the one or more functional layers contains less than 0.5% anionic surfactants, based on the dry weight of the functional layer.

5. The wireless label construction of claim 1, wherein the acrylic emulsion comprises 30 to 98% of an alkyl acrylate, based on the dry weight of the functional layer.

6. The wireless label construction of claim 1, wherein the acrylic emulsion comprises 1 to 10% of an unsaturated carboxylic acid, based on the dry weight of the functional layer.

7. The wireless label construction of claim 1, wherein the acrylic emulsion comprises 15 to 30% of a vinyl ester, based on the dry weight of the functional layer.

8. The wireless label construction of claim 1, wherein the acrylic emulsion comprises 10 to 40% of a dicarboxylic acid, based on the dry weight of the functional layer.

9. The wireless label construction of claim 1, wherein the acrylic emulsion comprises less than 3% of polyvinyl alcohol, based on the dry weight of the functional layer.

10. The wireless label construction of claim 1, wherein the acrylic emulsion comprises a crosslinker.

11. The wireless label construction of claim 10, wherein crosslinker is in an amount from 0.05 to 2% by weight, based on the dry weight of the functional layer.

12. The wireless label construction of claim 1, wherein the acrylic emulsion contains less than 0.5% of polyfunctional alcohols, polyoxyalkylenes or polyoxyalkylene derivatives, based on the dry weight of the functional layer.

13. The wireless label construction of claim 1, wherein the expandable particles comprise a core and a polymeric shell.

14. The wireless label construction of claim 13, wherein the core comprises a hydrocarbon.

15. The wireless label construction of claim 13, wherein the hydrocarbon comprises isobutane, isopentane, or combinations thereof.

16. The wireless label construction of claim 13, wherein the polymeric shell is selected from the group consisting of vinylidene chloride-acrylonitrile copolymers, polyvinyl alcohols, polyvinyl butyrals, polymethyl methacrylates, polyacrylonitriles, polyvinylidene chlorides, polysulfones, or combinations thereof.

17. The wireless label construction of claim 1, wherein the expandable particles comprise encapsulated water and a rupturable shell, wherein the rupturable shell comprises silica, paraffin, waxes, or triglyceride.

18. The wireless label construction of claim 1, wherein the polymeric matrix is coated with an organic acid or basic compound.

19. The wireless label construction of claim 1, wherein the face layer encapsulates the one or more functional layers.

20. The wireless label construction of claim 1, wherein the wireless identification device comprises:
an impedance-matching loop having straps for connecting an integrated circuit chip at each end, wherein the ends of the impedance-matching loop terminate within the impedance-matching loop, and
an antenna having an inner edge that surrounds at least a portion of the impedance-matching loop and is separated from the impedance-matching loop by a gap.
